(19) United States
(12) Patent Application Publication
(10) Pub. No.: US 2026/0113427 A1
(43) Pub. Date: Apr. 23, 2026

(54) METHOD AND SYSTEM FOR TRACKING HAND OF A USER

(71) Applicant: SAMSUNG ELECTRONICS CO., LTD., Suwon-si (KR)

(72) Inventors: Meghana SHANKAR, Bangalore (IN); Bindigan Hariprasanna PAWAN PRASAD, Bangalore (IN); Vishakha S R, Bangalore (IN); Green Rosh K S, Bangalore (IN); Sungsoo CHOI, Suwon-si (KR); Hyuntaek WOO, Suwon-si (KR)

(73) Assignee: SAMSUNG ELECTRONICS CO., LTD., Suwon-si (KR)

(21) Appl. No.: 19/256,920

(22) Filed: Jul. 1, 2025

Related U.S. Application Data
(63) Continuation of application No. PCT/KR2025/008791, filed on Jun. 24, 2025.

(30) Foreign Application Priority Data
Oct. 23, 2024 (IN) 202441080618

(51) Int. Cl. H04N 13/366; G06F 3/01; G06V 40/10; H04N 13/00; H04N 13/106

(52) U.S. Cl. CPC H04N 13/366; G06F 3/017; G06V 40/11; H04N 13/106; H04N 2013/0085

(57) ABSTRACT

A method for tracking a hand of a user immersed in an Extended Reality (XR) session includes determining a context of an operation of a Head-Mounted Display (HMD) device and a position of the hand with reference to an input scene; estimating landmarks associated with the hand based on the context; classifying the landmarks into one of a first group of one or more occluded landmarks and a second group of one or more non-occluded landmarks; predicting a position of the first group using an artificial intelligence (AI) model based on obtaining hand kinematics associated with the user and the context of the operation; rendering the hand in the XR session based on the second group and the predicted position of the first group; and tracking the hand based on rendering the hand in the XR session.

### CROSS-REFERENCE TO RELATED APPLICATIONS

This application is a continuation of PCT International Application No. PCT/KR2025/008791, which was filed on Jun. 24, 2025, and claims priority to Indian Patent Application number 202441080618, filed on Oct. 23, 2024, in the Indian Patent Office, the disclosures of each of which are incorporated by reference herein their entirety.

### BACKGROUND

### 1. Field

The present disclosure relates to Extended reality (XR) systems, and more particularly, to a method and a system for tracking at least one hand of a user immersed in an XR session.

### 2. Description of Related Art

The information in this section merely provides background information related to the present disclosure and may not constitute prior art(s) for the present disclosure.

Head-wearable apparatuses such as a Head-Mounted Display (HMD) or Virtual Studio Technology (VST) are implemented with a transparent or semi-transparent display through which a user of the head-wearable apparatuses can view a surrounding environment and objects (e.g., virtual objects such as a rendering of a two-dimensional (2D) or a three-dimensional (3D) graphic model, images, video, text, and so forth) that are generated for display to appear as a part of, and/or overlaid upon, the surrounding environment. This is referred to as “Extended reality (XR)”.

When the user is immersed in an XR session, the user is required to provide input to the head-wearable apparatuses to get engaged in the XR session. The hands of the user are the primary mode of input to the head-wearable apparatuses. Therefore, accurate hand tracking is important when interacting with XR objects.

Especially for use cases such as virtual keyboards, virtual drawing, etc., tracking fingertips is highly important for a seamless user experience. However, in hand-tracking techniques of the related art, while tracking the hand of the user by a head-wearable apparatus, a palm of the user is visible, and fingers are occluded when viewed form the head-wearable apparatus. Thus, key points associated with the occluded fingers are rendered incorrectly, thereby hindering hand-tracking accuracy.

More specifically, in the related art hand-tracking techniques, natural poses of the hands while interacting with the XR objects cause severe occlusions of the fingers, which could lead to incorrect estimation of end landmarks of the hand. Further, this occlusion could lead to estimating wrong buttons pressed/wrong inputs taken from input devices (screen windows, virtual keyboards, etc.).

Further, this occlusion could also degrade user experience when wrong inputs are chosen, and frustration in trying to keep the fingers visible.

Furthermore, people with particular disabilities such as Parkinsons, Essential Tremors (ET), etc, and even alcohol users have shaky hands, which is a characteristic of the associated medical condition. In these cases, hand tracking degrades because the related art hand-tracking techniques rely on previous frames to estimate a hand pose, which could lead to a disorientated mean pose. The estimate of the landmarks would be very noisy, leading to wrong selections, frustrating the user, and failure to produce a seamless user experience.

Thus, there is a need for a method and system that may accurately detect the fingertips of the user even in the case of self-occlusions.

In this regard, there is a need for an alternative solution that may overcome above above-discussed limitations.

The drawbacks/difficulties/disadvantages/limitations of the related art techniques explained in the background section are just for example purposes and the disclosure would never limit its scope only such limitations. A person skilled in the art would understand that this disclosure and below mentioned description may also solve other problems or overcome the other drawbacks/disadvantages.

### SUMMARY

This summary is provided to introduce a selection of concepts, in a simplified format, that are further described in the detailed description of the disclosure. This summary is neither intended to identify essential inventive concepts of the disclosure nor is it intended for determining the scope of the disclosure.

According to an aspect of the disclosure, a method for tracking at least one hand of a user immersed in an Extended Reality (XR) session, includes: identifying a context of an operation of a head-mounted display (HMD) device and a position of the at least one hand of the user with reference to an input scene; estimating a plurality of landmarks associated with the at least one hand of the user based on the context of the operation, wherein the plurality of landmarks indicates a set of key points on the at least one hand of the user; classifying the plurality of landmarks into one of a first group of one or more occluded landmarks and a second group of one or more non-occluded landmarks; predicting a position of the first group of the one or more occluded landmarks using an artificial intelligence (AI) model based on obtaining hand kinematics associated with the user and the context of the operation; rendering the at least one hand of the user in the XR session based on the second group of the one or more non-occluded landmarks and the predicted position of the first group of the one or more occluded landmarks; and tracking the at least one hand of the user based on rendering the at least one hand of the user in the XR session.

According to an aspect of the disclosure, a system for tracking at least one hand of a user immersed in an extended reality (XR) session, includes: memory storing one or more instructions; and at least one processor operatively coupled to the memory, wherein the one or more instructions, when executed by the at least one processor, cause the system to: identify a context of an operation of a head-mounted display (HMD) device and a position of the at least one hand of the user with reference to an input scene; estimate a plurality of landmarks associated with the at least one hand of the user based on the context of the operation, wherein the plurality of landmarks indicates a set of key points on the at least one hand of the user; classify the plurality of landmarks into one of a first group of one or more occluded landmarks and a second group of one or more non-occluded landmarks; predict a position of the first group of the one or more occluded landmarks using an artificial intelligence (AI) model based on obtaining hand kinematics associated with the user and the context of the operation; render the at least one hand of the user in the XR session based on the second group of the one or more non-occluded landmarks and the predicted position of the first group of the one or more occluded landmarks; and track the at least one hand of the user of based on rendering the at least one hand of the user in the XR session.

According to an aspect of the disclosure, a non-transitory computer readable medium has instructions stored therein, which when executed by a processor cause the processor to execute a method for tracking at least one hand of a user immersed in an Extended Reality (XR) session, the method including: identifying a context of an operation of a head-mounted display (HMD) device and a position of the at least one hand of the user with reference to an input scene; estimating a plurality of landmarks associated with the at least one hand of the user based on the context of the operation, wherein the plurality of landmarks indicates a set of key points on the at least one hand of the user; classifying the plurality of landmarks into one of a first group of one or more occluded landmarks and a second group of one or more non-occluded landmarks; predicting a position of the first group of the one or more occluded landmarks using an artificial intelligence (AI) model based on obtaining hand kinematics associated with the user and the context of the operation; rendering the at least one hand of the user in the XR session based on the second group of the one or more non-occluded landmarks and the predicted position of the first group of the one or more occluded landmarks; and tracking the at least one hand of the user based on rendering the at least one hand of the user in the XR session.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

These and other features, aspects, and advantages of certain embodiments of the present disclosure will be more apparent from the following description taken in conjunction with the accompanying drawings, in which:

FIG. 1 illustrates a schematic block diagram of a system for tracking at least one hand of a user, in accordance with an embodiment of the present disclosure;

FIG. 2 illustrates a schematic block diagram depicting a plurality of modules, in accordance with an embodiment of the present disclosure;

FIG. 3 illustrates a flowchart depicting an example method for tracking the at least one hand of the user, in accordance with an embodiment of the present disclosure;

FIG. 4 illustrates a flowchart depicting sub-steps for identifying a context of an operation, in accordance with an embodiment of the present disclosure;

FIG. 5 illustrates a flowchart depicting sub-steps for identifying a presence of one or more occluded landmarks, in accordance with an embodiment of the present disclosure;

FIG. 6 illustrates a flowchart depicting sub-steps for predicting a position of the one or more occluded landmarks, in accordance with an embodiment of the present disclosure;

FIG. 7 illustrates an example process flow for retrieving fingertip locations, in accordance with an embodiment of the present disclosure;

FIG. 8 illustrates an example representation for estimating a rotation of finger joints, in accordance with an embodiment of the present disclosure;

FIG. 9 illustrates an example representation of predicting the position of the one or more occluded landmarks and updating landmarks, in accordance with an embodiment of the present disclosure; and

FIG. 10 illustrates an example representation of determining a stable pose associated with the at least one hand of the user, in accordance with an embodiment of the present disclosure.

### DETAILED DESCRIPTION

For the purpose of promoting an understanding of the principles of the present disclosure, reference will now be made to the various embodiments and specific language will be used to describe the same. It should be understood at the outset that although illustrative implementations of the embodiments of the present disclosure are illustrated below, the present disclosure may be implemented using any number of techniques, whether currently known or in existence. The present disclosure is not necessarily limited to the illustrative implementations, drawings, and techniques illustrated below, including the example design and implementation illustrated and described herein, but may be modified within the scope of the present disclosure.

It will be understood by those skilled in the art that the foregoing general description and the following detailed description are explanatory of the disclosure and are not intended to be restrictive thereof.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

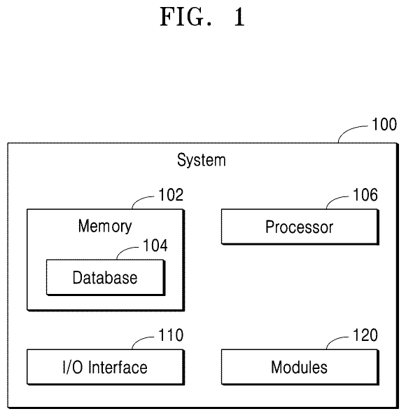

FIG. 1 illustrates a schematic block diagram of a system 100 for tracking at least one hand of the user, in accordance with an embodiment of the present disclosure.

In an embodiment, the system 100 may include a memory 102 including a database 104, a processor 106 communicatively coupled with the memory 102, an Input/Output (I/O) interface 110, and a plurality of modules 120. In an embodiment, the system 100 may be implemented by a User Equipment (UE). In a non-limiting example, the UE may be a smartphone, a laptop computer, a desktop computer, a Personal Computer (PC), a notebook, a tablet, or a smartwatch.

In an embodiment, the system 100 may be implemented by a cloud-based system, that may include one or more servers, such as one or more cloud servers. In yet another embodiment, the system 100 may be implemented by a combination of the UE and the server. More specifically, one or more steps may be performed in the UE and the remaining steps may be performed by the server. In yet another embodiment, the system 100 may be implemented by head-wearable apparatuses such as a head-mounted display (HMD) device.

In an embodiment, the memory 102 is configured to store instructions executable by the processor 106. In one embodiment, the memory 102 communicates via a bus within the system 100. The memory 102 includes but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory includes a cache or random-access memory (RAM) for the processor 106. In an embodiment, the memory 102 is separate from the processor 106 such as a cache memory of a processor, the system memory, or other memory. The memory 102 is an external storage device or the memory 102 is for storing data. The memory 102 is operable to store instructions executable by the processor 106. The functions, acts, or tasks illustrated in the figures or described are performed by the programmed processor for executing the instructions stored in the memory 102. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies include multiprocessing, multitasking, parallel processing, and the like.

As a non-limiting example, the processor 106 may be a single processing unit or a set of units each including multiple computing units. The processor 106 may be implemented as one or more microprocessors, microcomputers, microcontrollers, digital signal processors, central processing units, state machines, logic circuitries, and/or any devices that manipulate signals based on operational instructions (computer-readable instructions) stored in the memory 102. Among other capabilities, the processor 106 may be configured to fetch and execute computer-readable instructions and data stored in the memory 102. The processor 106 includes one or a plurality of processors. The plurality of processors is further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). The plurality of processors controls the processing of the input data in accordance with a predefined operating rule or an artificial intelligence (AI) model stored in the memory 102. The predefined operating rule or the AI model is provided through training or learning.

The processor 106 may be disposed in communication with one or more input/output (I/O) devices via the Input/Output (I/O) interface 110. The I/O interface 110 employs communication Code-Division Multiple access (CDMA), High-Speed Packet Access (HSPA+), Global System for Mobile Communications (GSM), Long-Term Evolution (LTE), WiMax, and the like, etc. In another embodiment of the present disclosure, the I/O interface 110 employs ethernet, industrial wireless Local Area Network (LAN), Process Field Bus (PROFIBUS), Actuator Sensor (AS) Interface, and the like.

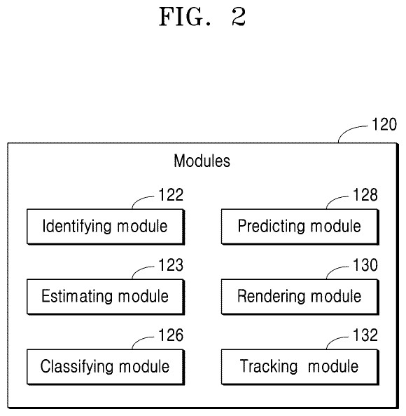

FIG. 2 illustrates a schematic block diagram depicting a plurality of modules 120, in accordance with an embodiment of the present disclosure. The plurality of modules 120 may include the one or more instructions that may be executed to cause the system 100, in particular, the processor 106 of the system 100, to execute the one or more instructions. In one or more examples, each module may be implemented by one or more processors. In one or more examples, each module may be implemented one or more circuits designed to perform one or more functions of a respective module.

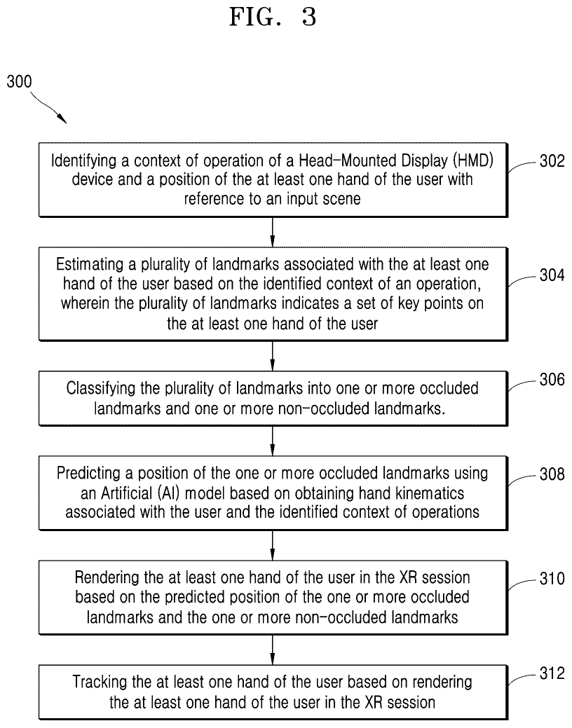

The plurality of modules 120 may include an identifying module 122, an estimating module 124, a classifying module 126, a predicting module 128, a rendering module 130, and a tracking module 132. In an embodiment, the identifying module 122, the estimating module 124, the classifying module 126, the predicting module 128, the rendering module 130, and the tracking module 132 may be in communication with each other. The identifying module 122 may also be referred to as a determining module. In an embodiment, the plurality of modules 120 may be configured to perform various operations or steps that may be discussed and explained in detail in conjunction with FIGS. 3-6.

A detailed explanation of various functions of the processor 106, and/or the plurality of modules 120 may be explained in view of FIGS. 3-6.

FIG. 3 illustrates a flowchart depicting an example method 300 for tracking the at least one hand of the user, in accordance with an embodiment of the present disclosure. In an embodiment, the method 300 is a computer-implemented method 300 that is explained in detail in the below paragraphs.

Referring to FIG. 3, the method 300 may begin with operation 302 which may include identifying, via the identifying module 122, a context of an operation of the HMD device and a position of the at least one hand of the user with reference to an input scene. In an embodiment, the input scene may be captured by a camera that may be installed in the HMD device.

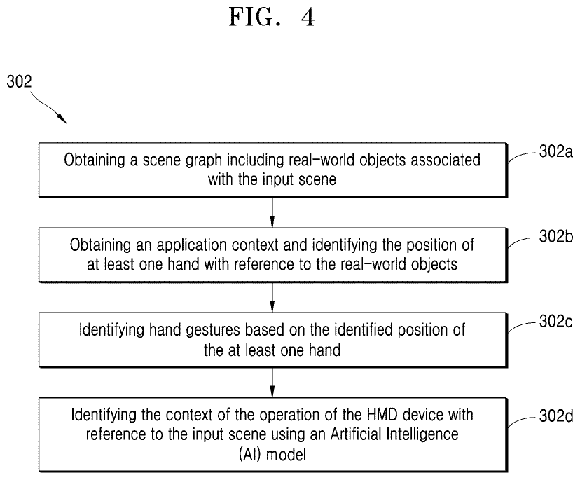

In an embodiment, the identification of the context of the operation is discussed in conjunction with FIG. 4.

FIG. 4 illustrates a flowchart depicting sub-steps for identifying the context of the operation, in accordance with an embodiment of the present disclosure.

At sub-step 302a, the step 302 may include obtaining a scene graph associated with the input scene. More specifically, a scene graph may be obtained using Simultaneous Localization and Mapping (SLAM). The scene graph may provide a location of real-world objects in the input scene. For example, a scene graph may be a data structure that provides a spatial representation of the real-world objects in a scene.

Further, at sub-step 302b, the step 302 may include obtaining an application context and identifying the position of at least one hand with reference to the real-world objects. In an example scenario, the application context may refer to one or more applications in which the user may be engaged. In an example scenario, the system 100 may identify the applications that may be on top of a user interface, and based on that, the system 100 may identify the applications on which the user mostly engaged.

At sub-step 302c, the step 302 may include identifying, via the identifying module 122, hand gestures based on the identified position of the at least one hand.

At sub-step 302d, the step 302 may include identifying, via the identifying module 122, the context of the operation of the HMD device with reference to the input scene using an Artificial Intelligence (AI) model. In an embodiment, the context may be identified based on the obtained scene graph, the application context, and the identified hand gestures. In an example scenario, the AI model may identify an operation performed by the user in a vicinity of the real-world objects and/or virtual objects referred to as XR objects within the scope of the present disclosure. For example, the XR objects may include, but are not limited to, virtual keyboards, a mouse, a home screen, an application screen, or the like.

In one embodiment, the identified context of the operation may be transmitted to a corpus (e.g., the database 104). The corpus may include a pre-calibrated hand and signature model of the user. For example, the pre-calibrated hand and signature model may correspond to the XR objects (virtual keyboard, home screen, etc). In one or more example, the pre-calibrated hand and signature model may be images of various hand gestures (e.g., one or more raised fingers, waving gesture, grab gesture, etc.) that are correlated with an identified context or command.

In an example scenario, if a virtual keyboard is open in a virtual reality space and the user's hand is hovering close to it, then the system may assume that the user is trying to use the keyboard. In another example scenario, if an XR object is in front of the user and the hand gesture is similar to a grab gesture, then the system may assume that the user wants to grab the object. In yet another example scenario, if a real mug is in front of the user in the real world, then the system may assume that when the user performs a gesture similar to grabbing, the user may grab the real mug and not interact with the XR objects.

At step 304, the method 300 may include estimating, via the estimating module 124, a plurality of landmarks associated with the at least one hand of the user based on the identified context of an operation. The plurality of landmarks may herein refer to a set of key points on the at least one hand of the user. More specifically, the plurality of landmarks may be associated with finger joints and/or fingertips of the at least one hand of the user.

At step 306, the method 300 may include classifying, via the classifying module 126, the plurality of landmarks into one or more occluded landmarks and one or more non-occluded landmarks. In an embodiment, the one or more occluded landmarks herein refer to the landmarks that may not be visible while capturing the context of the operation and are degraded. In one or more examples, a landmark may be occluded if a predetermined percentage of the landmark is occluded. For example, a landmark may be occluded if more than 20% of the landmark is occluded. The one or more occluded landmarks may be referred to as belonging to a first group, and the non-occluded landmarks may be referred to as belonging to a second group.

In an embodiment, the one or more non-occluded landmarks herein refer to landmarks that may be clearly visible while capturing the context of the operation. For example, the one or more occluded landmarks may be present at the end of fingers which may also be termed as end landmarks or tip landmarks within the scope of the present disclosure.

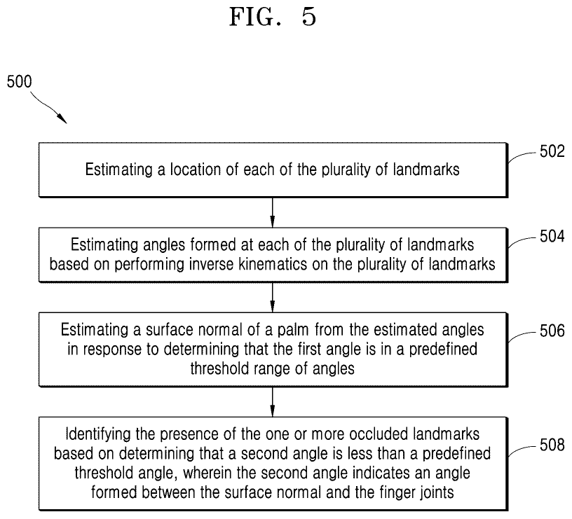

In one embodiment, the identification of the presence of the one or more occluded landmarks is discussed in conjunction with FIG. 5.

FIG. 5 illustrates a flowchart 500 depicting sub-steps for identifying the presence of the one or more occluded landmarks, in accordance with an embodiment of the present disclosure.

At step 502, the method may include estimating, via the estimating module 124, a location of each of the plurality of landmarks.

At step 504, the method may include estimating, via the estimating module 124, angles formed at each of the plurality of landmarks based on performing inverse kinematics on the plurality of landmarks.

At step 506, the method may include determining, via the estimating module, 124 a first angle formed at a twist axis of a wrist of the user based on the estimated angles. In an embodiment, the first angle herein refers to a twist angle associated with the hand of the user. In an example scenario, the twist angle indicates the rotation angle, that the wrist makes with respect to forward-facing position. The method may include estimating, via the estimating module 124, a surface normal of the palm from the estimated angles in response to determining that the first angle is in a predefined threshold range of angles. In an example scenario, the predefined threshold range of angles is 160 degrees to 180 degrees.

In the first example scenario, when the twist angle is zero degrees, the palm is facing the user, and the fingertips are visible. Therefore, there may be a minimal chance of a presence of the one or more occluded landmarks, which may lead to minimal degradation.

In another example scenario, when the twist angle is between 160 degrees and 180 degrees, the palm is facing away from the user, and the fingertips may occlude each other. This may cause degradation in detecting the plurality of landmarks, which may lead to inaccurate tracking of the at least one hand.

In yet another example scenario, when the twist angle is 180 degrees, there may be a maximum chance of the presence of the one or more occluded landmarks, which may cause higher degradation.

At step 508, the method may include identifying, via the identifying module 122, the presence of the one or more occluded landmarks based on determining that a second angle is less than a predefined threshold angle. In an embodiment, the second angle may herein refer to an angle formed between the surface normal and the finger joints. In an example scenario, the predefined threshold angle is 90 degrees.

Classifying the plurality of landmarks into one of the first group of one or more occluded landmarks and a second group of one or more non occluded landmarks can improve the estimation by allowing the algorithm to learn user behaviour when the landmarks are not occluded and to estimate the tip landmarks when the landmarks are occluded.

Again, referring to FIG. 3, at step 308, the method 300 may include predicting, via the predicting module 128, a position of the one or more occluded landmarks using the AI model based on obtaining hand kinematics associated with the user and the identified context of the operation.

In an embodiment, a user's behaviour may be learned with respect to the XR objects. More specifically, a contact of the end landmarks with the XR objects and a call back from the XR objects on a position of touch may be recorded and stored in the database 104 that may be mapped to a particular XR object. The user's behaviour may indicate a pattern of interaction with the XR objects. The database 104 (e.g., the corpus) may include the hand kinematics associated with each user that may be mapped with the XR objects based on the interaction of each user. More particularly, each user may have a different pattern of interaction, the system 100 leverages this different pattern of interaction along with the hand kinematics to predict the position of the one or more occluded landmarks.

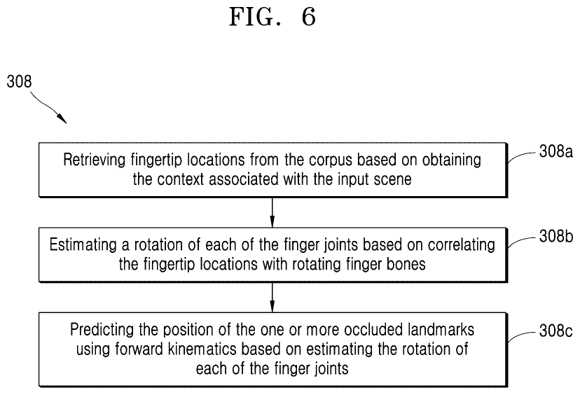

FIG. 6 illustrates a flowchart depicting sub-steps for predicting the position of the one or more occluded landmarks, in accordance with an embodiment of the present disclosure.

At sub-step 308a, the step 308 may include retrieving fingertip locations from the corpus may be based on obtaining the context associated with the input scene.

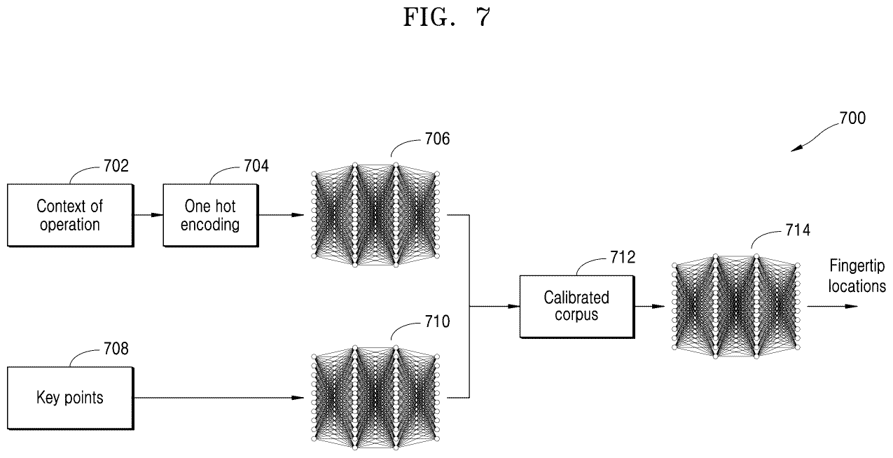

FIG. 7 illustrates an example process flow 700 for retrieving the fingertip locations, in accordance with an embodiment of the present disclosure.

At block 702, the context of the operation is obtained. The context of the operation may be scene context. The scene context may be identified based on the scene graph, the application context, and the hand gestures. At block 704, the context is passed to a one hot encoding model. As understood by one of ordinary skill in the art, one hot encoding may refer to a technique that converts categorical data into numerical values that may be used by machine learning algorithms (e.g., method for preparing categorical data for machine learning). Further, at block 706, the context may be processed in a deep context encoder for encoding the context of the operation. The deep context encoder may be implemented using a first multilayer perceptron. Simultaneously, at block 708, the set of key points may be estimated. For example, the set of key points may be associated with finger joints and/or fingertips of the at least one hand of the user. At block 710, the set of key points may be passed to a deep key point encoder to obtain deep features associated with the set of key points. The deep key point encoder may be implemented using a second multilayer perceptron. Further, at block 712, the encoded context and the deep features may utilize the database 104 (e.g., the corpus) to obtain information such as a tip depression, a tip translation, and a tip angle. Further, at block 714, the information may be processed in a regressive model to obtain the fingertips locations. The regressive model may be implemented using a third multilayer perceptron.

At sub-step 308b, the step 308 may include estimating, via the estimating module 124, a rotation of each of the finger joints based on correlating the fingertip locations with rotating finger bones. In an embodiment, firstly the fingertip locations may be matched based on the rotating finger bones. Thereafter, the rotation of each finger of the finger joints by using inverse kinematics based on the matched fingertip locations. As understood by one of ordinary skill in the art, inverse kinematics may refer to a mathematical process that calculates how to move a series of connected parts to reach a desired position, Inverse kinematics may be performed by (i) specifying a desired position and orientation of an end effector (e.g., fingertip), (ii) calculate the joint angles needed to reach the desired position, and (iii) rotate each joint to achieve the desired position.

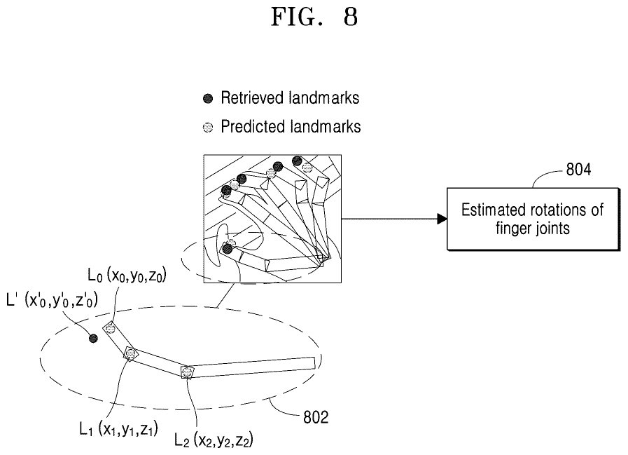

In an example scenario, the estimation of the rotation, specifically the estimation of the rotation of the finger joints is explained in the following steps in conjunction with FIG. 8.

Consider a thumb as illustrated for the estimation of the rotation of the finger joints as illustrated in FIG. 8.

Referring to 802, let L₀(x₀,y₀,z₀) be the predicted position of a fingertip.

Let L′(x′₀,y′₀,z′₀) be the retrieved position of the fingertip.

Let L₁(x₁,y₁,z₁) & L₂(x₂,y₂,z₂) be predicted positions of a landmark just before the fingertip.

The joint rotation at L₁ is given by equation (1) as below:

$$θ = {cos}^{- 1} [ \frac{( {L}_{2} - {L}_{1} ) \cdot ( {L}_{1} - {L}_{0} )}{\vert {L}_{2} - {L}_{1} \vert \cdot \vert {L}_{1} - {L}_{0} \vert} ] \qquad ( 1 )$$

The new joint rotation is estimated as illustrated in block 804, using the retrieved joint location as equation (2) below:

$$θ = {cos}^{- 1} [ \frac{( {L}_{2} - {L}_{1} ) \cdot ( {L}_{1} - {L}_{0}^{′} )}{\vert {L}_{2} - {L}_{1} \vert \cdot \vert {L}_{1} - {L}_{0}^{′} \vert} ] \qquad ( 2 )$$

At sub-step 308c, the step 308 may include predicting the position of the one or more occluded landmarks using forward kinematics based on estimating the rotation of each of the finger joints. As understood by one of ordinary skill in the art, forward kinematics may refer to a process that calculates a position and orientation of an end effector (e.g., fingertip) based on angles and positions of associated joints. Forward kinematics may be performed by (i) specifying the values of joint parameters, and (ii) calculating the position and orientation of the end effector.

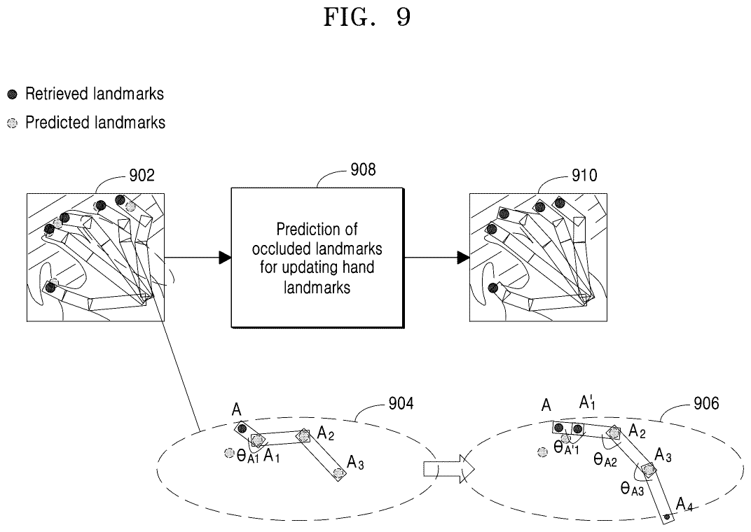

In an example scenario, the prediction of the one or more occluded landmarks of a middle finger is explained in the following steps in conjunction with FIG. 9. Referring to FIG. 9, 902 corresponds to the estimated rotation of each of the finger joints.
Referring to 904, let an angle between two-line segments AA₁ and A₁A₂ be shown using equation (3) as below:

$${θ}_{A 1} = 200 ° \qquad ( 3 )$$

Further, the angle at a specific joint should be in the range of 90° to 180°.
Thereafter, rotating a line segment AA₁ by fixing A as a pivot, based on comparing θ_{A1} with the above-mentioned ranges.
Referring to 906, A′₁ is the estimated position after rotation, and the angle at A′₁ is shown using equation (4) as below:

$${θ}_{{A}^{′} 1} = 180 ° \qquad ( 4 )$$

Now, the landmarks A and A′₁ are fixed, let us consider the angle at A₂.
Let the angle between the two-line segments A′₁A₂ and A₂A₃ be shown using equation (5) as below:

$${θ}_{A 2} = 120 ° \qquad ( 5 )$$

Referring to 906, the angle θ_{A}_{₂} is in the permissible range of 90° to 180°.
Thus, move on to the angle at A₃.
Let the angle between the two-line segments A₂A₃ and A₃A₄ be shown by equation (6) as below:

$${θ}_{A 3} = 170 ° \qquad ( 6 )$$

Further referring to 906, the angle θ_{A}_{₃} is in the permissible range of 90° to 180°.
Thus, all the one or more occluded landmarks on the middle finger are predicted and the plurality of landmarks are updated based on the predicted occluded landmarks as shown in block 908.
Referring to 910, the same steps are performed as above on all the fingers to update all the landmarks of the hand.

In one embodiment, hand descriptors map from higher Metacarpophalangeal (MCP), Proximal Interphalangeal (PIP), and Distal Interphalangeal (DIP) landmarks to the tip landmarks are stored in the database 104 for each virtual interactive object. Hence when the user is using a particular VR object, the user's behaviour is extracted from the database 104 for the particular object. Therefore, the pattern is now used to estimate end landmarks that may be the one or more occluded landmarks, from the non-occluded landmarks visible to the HMD device. These techniques enable seamless interaction, where faster and more accurate end landmark tracking may be achieved.

Referring to FIG. 3, at step 310, the method 300 may include rendering, via the rendering module 130, the at least one hand of the user in the XR session based on the predicted position of the one or more occluded landmarks and the one or more non-occluded landmarks. In an example scenario, all the updated landmarks of the hand of the user are utilized to render the hand of the user in the XR session.

At step 312, the method 300 may include tracking, via the tracking module 132, the at least one hand of the user based on rendering the at least one hand of the user in the XR session.

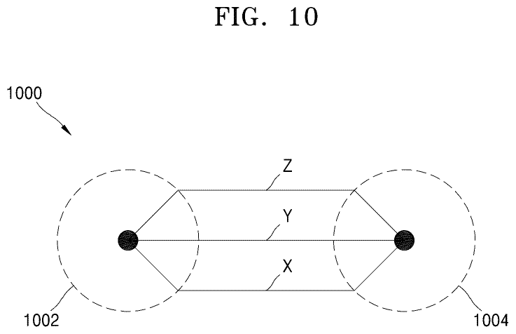

FIG. 10 illustrates an example representation 1000 of determining a stable pose associated with the at least one hand of the user, in accordance with an embodiment of the present disclosure. In an embodiment, three possible finger configurations may be possible which may be depicted as a first finger configuration (X), a second finger configuration (Y), and a third finger configuration (Z) based on knuckle locations 1002 and the fingertip locations 1004. In an embodiment, the first finger configuration (X) may be eliminated using biomechanical constraints. The second finger configuration (Y) may be eliminated using the user's behaviour that is stored in the database 104. Therefore, the third finger configuration may be selected, leading to the determination of the stable pose of the at least one hand of the user. Hence, removal of jittering which is caused by abruptly moving between the first finger configuration (X), the second configuration (Y), and the third finger configuration (Z) may lead to the stable pose of the at least one hand of the user.

In an example use case, tremors in the user's stable hand pose pattern are recorded in a mapper associated with the XR, with the range of displacements along the rotations of the finger joints. The tip positions, translations, and depressions are calculated with respect to a mean-variance in the user's hand pattern. In an embodiment, when estimating, the noise in terms of variance is removed, and a position of the plurality of landmarks is estimated which are stable. More specifically, the present disclosure accurately estimates the end landmarks based on the user's behaviour, and continuously learns the user's behaviour. The mapper updates the user pattern and leverages to produce seamless experience.

In various embodiments, the present disclosure at least provides the following advantages. The present disclosure accurately predicts the locations of the fingertips when the fingertips are occluded for various reasons, even in the case of self-occlusions. Further, the present disclosure enables accurate estimation of the input provided by the user due to accurate prediction of the one or more occluded landmarks. Furthermore, the present disclosure enhances user experience when interacting with the XR objects due to smooth and accurate predictions of the one or more occluded landmarks. The present disclosure is adapted to learn the user's behaviour with the XR objects and stores the learned behaviour in the database 104 mapped to the particular XR object. The present disclosure allows the user to provide the input at a faster rate due to learning of the user's behaviour. Moreover, the present disclosure enables the tracking of the at least one hand of the user in low-light conditions.

The embodiments disclosed herein can be implemented through at least one software program running on at least one hardware device and performing network management functions to control the elements. The elements can be at least one of a hardware device or a combination of hardware devices and software modules.

According to an embodiment of the disclosure, a method for tracking at least one hand of a user immersed in an Extended Reality (XR) session may include identifying a context of an operation of a head-mounted display (HMD) device and a position of the at least one hand of the user with reference to an input scene. The method may include estimating a plurality of landmarks associated with the at least one hand of the user based on the context of the operation, wherein the plurality of landmarks indicates a set of key points on the at least one hand of the user. The method may include classifying the plurality of landmarks into one of a first group of one or more occluded landmarks and a second group of one or more non-occluded landmarks. The method may include predicting a position of the first group of the one or more occluded landmarks using an artificial intelligence (AI) model based on obtaining hand kinematics associated with the user and the context of the operation. The method may include rendering the at least one hand of the user in the XR session based on the predicted position of the first group of the one or more occluded landmarks and the second group of the one or more non-occluded landmarks. The method may include tracking the at least one hand of the user based on rendering the at least one hand of the user in the XR session.

According to an embodiment of the disclosure, the input scene may be captured by a camera of the HMD device.

According to an embodiment of the disclosure, the plurality of landmarks may be associated with at least one of finger joints and fingertips of the at least one hand of the user.

According to an embodiment of the disclosure, the hand kinematics may be obtained from a corpus that includes at least a pre-calibrated hand and signature model of the user.

According to an embodiment of the disclosure, the classifying of the plurality of landmarks into one of the first group of the one or more occluded landmarks and the second group of the one or more non-occluded landmarks may include identifying a presence of at least one occluded landmark in the first group of the one or more occluded landmarks. The classifying of the plurality of landmarks into one of the first group and the second group may include identifying a presence of at least one non-occluded landmark in the second group of the one or more non-occluded landmarks.

According to an embodiment of the disclosure, the identifying of the presence of the at least one occluded landmark in the first group of the one or more occluded landmarks may include estimating a location of each of the plurality of landmarks. The identifying of the presence of the at least one occluded landmark in the first group may include estimating angles formed at each of the plurality of landmarks based on performing inverse kinematics on the plurality of landmarks. The identifying of the presence of the at least one occluded landmark in the first group may include determining a first angle formed at a twist axis of a wrist of the user based on estimating angles. The identifying of the presence of the at least one occluded landmark in the first group may include, based on determining that the first angle is in a predefined threshold range of angles, estimating a surface normal of a palm from the estimated angles. The identifying of the presence of the at least one occluded landmark in the first group may include, based on determining that a second angle formed between the surface normal and finger joints of the user is less than a predefined threshold angle, identifying the presence of the at least one occluded landmark in the first group of the one or more occluded landmarks.

According to an embodiment of the disclosure, the predicting of the position of the first group of the one or more occluded landmarks may include retrieving fingertip locations from the corpus based on obtaining the context associated with the input scene. The predicting of the position of the first group may include estimating a rotation of each finger joint based on correlating fingertip locations of the user with rotating finger bones of the user. The predicting of the position of the first group may include predicting the position of the one or more occluded landmarks using forward kinematics based on estimating the rotation of each finger joint of the user.

According to an embodiment of the disclosure, the estimating of the rotation of each finger joint may include matching the fingertip locations based on the rotating finger bones. The estimating of the rotation of each finger joint may include estimating the rotation of each finger joint using inverse kinematics based on the matching.

According to an embodiment of the disclosure, the identifying of the context of the operation may include identifying one or more real-world objects from the input scene using a Simultaneous Localization and Mapping (SLAM) model. The identifying of the context of the operation may include identifying the position of the at least one hand of the user with reference to the one or more real-world objects. The identifying of the context of the operation may include identifying one or more hand gestures based on the identified position. The identifying of the context of the operation may include identifying the context of the operation based on identifying one or more hand gestures.

According to an embodiment of the disclosure, a system for tracking at least one hand of a user immersed in an extended reality (XR) session may include memory storing one or more instructions and at least one processor operatively coupled to the memory. The one or more instructions, when executed by the at least one processor, cause the system to identify a context of an operation of a head-mounted display (HMD) device and a position of the at least one hand of the user with reference to an input scene. The one or more instructions, when executed by the at least one processor, cause the system to estimate a plurality of landmarks associated with the at least one hand of the user based on the context of the operation, wherein the plurality of landmarks indicates a set of key points on the at least one hand of the user. The one or more instructions, when executed by the at least one processor, cause the system to classify the plurality of landmarks into one of a first group of one or more occluded landmarks and a second group of one or more non-occluded landmarks. The one or more instructions, when executed by the at least one processor, cause the system to predict a position of the first group of the one or more occluded landmarks using an artificial intelligence (AI) model based on obtaining hand kinematics associated with the user and the context of the operation. The one or more instructions, when executed by the at least one processor, cause the system to render the at least one hand of the user in the XR session based on the predicted position of the first group of the one or more occluded landmarks and the second group of the one or more non-occluded landmarks. The one or more instructions, when executed by the at least one processor, cause the system to track the at least one hand of the user of based on rendering the at least one hand of the user in the XR session.

According to an embodiment of the disclosure, the input scene may be captured by a camera of the HMD device.

According to an embodiment of the disclosure, the plurality of landmarks may be associated with at least one of finger joints and fingertips of the at least one hand of the user.

According to an embodiment of the disclosure, the hand kinematics may be obtained from a corpus that includes at least a pre-calibrated hand and signature model of the user.

According to an embodiment of the disclosure, to classify the plurality of landmarks into one of the first group of the one or more occluded landmarks and the second group of the one or more non-occluded landmarks, the one or more instructions, when executed by the at least one processor, cause the system to identify a presence of at least one occluded landmark in the first group of the one or more occluded landmarks. The one or more instructions, when executed by the at least one processor, cause the system to identify a presence of at least one non-occluded landmark in the second group of the one or more non-occluded landmarks.

According to an embodiment of the disclosure, to identify the presence of the at least one occluded landmark in the first group of the one or more occluded landmarks, the one or more instructions, when executed by the at least one processor cause the system to estimate a location of each of the plurality of landmarks. The one or more instructions, when executed by the at least one processor, cause the system to estimate angles formed at each of the plurality of landmarks based on performing inverse kinematics on the plurality of landmarks. The one or more instructions, when executed by the at least one processor, cause the system to determine a first angle formed at a twist axis of a wrist of the user based on estimating angles. The one or more instructions, when executed by the at least one processor, cause the system to, based on determining that the first angle is in a predefined threshold range of angles, estimate a surface normal of a palm from the estimated angles. The one or more instructions, when executed by the at least one processor, cause the system to, based on determining that a second angle formed between the surface normal and finger joints of the user is less than a predefined threshold angle, identify the presence of the at least one occluded landmark in the first group of the one or more occluded landmarks wherein the second angle indicates an angle.

According to an embodiment of the disclosure, to predict the position of the first group of the one or more occluded landmarks, the one or more instructions, when executed by the at least one processor, cause the system to retrieve fingertip locations from the corpus based on obtaining the context associated with the input scene. The one or more instructions, when executed by the at least one processor, cause the system to estimate a rotation of each finger joint of the user based on correlating fingertip locations of the user with rotating finger bones of the user. The one or more instructions, when executed by the at least one processor, cause the system to predict the position of the one or more occluded landmarks using forward kinematics based on estimating the rotation of each finger joint.

According to an embodiment of the disclosure, to estimate the rotation of each of finger joint, the one or more instructions, when executed by the at least one processor, cause the system to match the fingertip locations based on the rotating finger bones. The one or more instructions, when executed by the at least one processor, cause the system to estimate the rotation of each finger joint using inverse kinematics based on matching.

According to an embodiment of the disclosure, to identify the context of the operation, the one or more instructions, when executed by the at least one processor, cause the system to identify one or more real-world objects from the input scene using a Simultaneous Localization and Mapping (SLAM) model. The one or more instructions, when executed by the at least one processor, cause the system to identify the position of the at least one hand of the user with reference to the one or more real-world objects; identify one or more hand gestures based on the determined position. The one or more instructions, when executed by the at least one processor, cause the system to identify the context of the operation based on identifying the one or more hand gestures.

According to an embodiment of the disclosure, a non-transitory computer readable medium has instructions stored therein, which when executed by a processor cause the processor to execute a method for tracking at least one hand of a user immersed in an Extended Reality (XR) session. The instructions, when executed by the processor, may cause the processor to identify a context of an operation of a head-mounted display (HMD) device and a position of the at least one hand of the user with reference to an input scene. The instructions, when executed by the processor, may cause the processor to estimate a plurality of landmarks associated with the at least one hand of the user based on the context of the operation, wherein the plurality of landmarks indicates a set of key points on the at least one hand of the user. The instructions, when executed by the processor, may cause the processor to classify the plurality of landmarks into one of a first group of one or more occluded landmarks and a second group of one or more non-occluded landmarks. The instructions, when executed by the processor, may cause the processor to predict a position of the first group of the one or more occluded landmarks using an artificial intelligence (AI) model based on obtaining hand kinematics associated with the user and the context of the operation. The instructions, when executed by the processor, may cause the processor to render the at least one hand of the user in the XR session based on the predicted position of the first group of the one or more occluded landmarks and the second group of the one or more non-occluded landmarks. The instructions, when executed by the processor, may cause the processor to track the at least one hand of the user based on rendering the at least one hand of the user in the XR session.

According to an embodiment of the disclosure, the input scene may be captured by a camera of the HMD device.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

What is claimed is:

1. A method for tracking at least one hand of a user immersed in an Extended Reality (XR) session, the method comprising:
identifying a context of an operation of a head-mounted display (HMD) device and a position of the at least one hand of the user with reference to an input scene;
estimating a plurality of landmarks associated with the at least one hand of the user based on the context of the operation, wherein the plurality of landmarks indicates a set of key points on the at least one hand of the user;
classifying the plurality of landmarks into one of a first group of one or more occluded landmarks and a second group of one or more non-occluded landmarks;
predicting a position of the first group of the one or more occluded landmarks using an artificial intelligence (AI) model based on obtaining hand kinematics associated with the user and the context of the operation;
rendering the at least one hand of the user in the XR session based on the second group of the one or more non-occluded landmarks and the predicted position of the first group of the one or more occluded landmarks; and
tracking the at least one hand of the user based on rendering the at least one hand of the user in the XR session.

2. The method as claimed in claim 1, wherein the input scene is captured by a camera of the HMD device.

3. The method as claimed in claim 1, wherein the plurality of landmarks is associated with at least one of finger joints and fingertips of the at least one hand of the user.

4. The method as claimed in claim 1, wherein the hand kinematics is obtained from a corpus that includes at least a pre-calibrated hand and signature model of the user.

5. The method as claimed in claim 1, wherein the classifying the plurality of landmarks into one of the first group of the one or more occluded landmarks and the second group of the one or more non-occluded landmarks comprises:
identifying a presence of at least one occluded landmark in the first group of the one or more occluded landmarks; and
identifying a presence of at least one non-occluded landmark in the second group of the one or more non-occluded landmarks.

6. The method as claimed in claim 5, wherein the identifying the presence of the at least one occluded landmark in the first group of the one or more occluded landmarks comprises:
estimating a location of each of the plurality of landmarks;
estimating angles formed at each of the plurality of landmarks based on performing inverse kinematics on the plurality of landmarks;
determining a first angle formed at a twist axis of a wrist of the user based on estimating angles;
based on determining that the first angle is in a predefined threshold range of angles, estimating a surface normal of a palm from the estimated angles; and
based on determining that a second angle formed between the surface normal and finger joints of the user is less than a predefined threshold angle, identifying the presence of the at least one occluded landmark in the first group of the one or more occluded landmarks.

7. The method as claimed in claim 4, wherein the predicting the position of the first group of the one or more occluded landmarks comprises:
retrieving fingertip locations from the corpus based on obtaining the context associated with the input scene;
estimating a rotation of each finger joint based on correlating fingertip locations of the user with rotating finger bones of the user; and
predicting the position of the one or more occluded landmarks using forward kinematics based on estimating the rotation of each finger joint of the user.

8. The method as claimed in claim 7, wherein the estimating the rotation of each finger joint comprises:
matching the fingertip locations based on the rotating finger bones; and
estimating the rotation of each finger joint using inverse kinematics based on the matching.

9. The method as claimed in claim 1, wherein the identifying the context of the operation comprises:
identifying one or more real-world objects from the input scene using a Simultaneous Localization and Mapping (SLAM) model;
identifying the position of the at least one hand of the user with reference to the one or more real-world objects;
identifying one or more hand gestures based on the identified position; and
identifying the context of the operation based on identifying one or more hand gestures.

10. A system for tracking at least one hand of a user immersed in an extended reality (XR) session, the system comprising:
memory storing one or more instructions; and
at least one processor operatively coupled to the memory,
wherein the one or more instructions, when executed by the at least one processor, cause the system to:
identify a context of an operation of a head-mounted display (HMD) device and a position of the at least one hand of the user with reference to an input scene;
estimate a plurality of landmarks associated with the at least one hand of the user based on the context of the operation, wherein the plurality of landmarks indicates a set of key points on the at least one hand of the user;
classify the plurality of landmarks into one of a first group of one or more occluded landmarks and a second group of one or more non-occluded landmarks;
predict a position of the first group of the one or more occluded landmarks using an artificial intelligence (AI) model based on obtaining hand kinematics associated with the user and the context of the operation;
render the at least one hand of the user in the XR session based on the second group of the one or more non-occluded landmarks and the predicted position of the first group of the one or more occluded landmarks; and
track the at least one hand of the user of based on rendering the at least one hand of the user in the XR session.

11. The system as claimed in claim 10, wherein the input scene is captured by a camera of the HMD device.

12. The system as claimed in claim 10, wherein the plurality of landmarks is associated with at least one of finger joints and fingertips of the at least one hand of the user.

13. The system as claimed in claim 10, wherein the hand kinematics is obtained from a corpus that includes at least a pre-calibrated hand and signature model of the user.

14. The system as claimed in claim 10, wherein to classify the plurality of landmarks into one of the first group of the one or more occluded landmarks and the second group of the one or more non-occluded landmarks, the at least one processor is configured to:
identify a presence of at least one occluded landmark in the first group of the one or more occluded landmarks; and
identify a presence of at least one non-occluded landmark in the second group of the one or more non-occluded landmarks.

15. The system as claimed in claim 14, wherein to identify the presence of the at least one occluded landmark in the first group of the one or more occluded landmarks, the one or more instructions, when executed by the at least one processor cause the system to:
estimate a location of each of the plurality of landmarks;
estimate angles formed at each of the plurality of landmarks based on performing inverse kinematics on the plurality of landmarks;
determine a first angle formed at a twist axis of a wrist of the user based on estimating angles;
based on determining that the first angle is in a predefined threshold range of angles, estimate a surface normal of a palm from the estimated angles; and
based on determining that a second angle formed between the surface normal and finger joints of the user is less than a predefined threshold angle, identify the presence of the at least one occluded landmark in the first group of the one or more occluded landmarks wherein the second angle indicates an angle.

16. The system as claimed in claim 13, wherein to predict the position of the first group of the one or more occluded landmarks, the one or more instructions, when executed by the at least one processor, cause the system to:
retrieve fingertip locations from the corpus based on obtaining the context associated with the input scene;
estimate a rotation of each finger joint of the user based on correlating fingertip locations of the user with rotating finger bones of the user; and
predict the position of the one or more occluded landmarks using forward kinematics based on estimating the rotation of each finger joint.

17. The system as claimed in claim 16, wherein to estimate the rotation of each of finger joint, the one or more instructions, when executed by the at least one processor, cause the system to:
match the fingertip locations based on the rotating finger bones; and
estimate the rotation of each finger joint using inverse kinematics based on matching.

18. The system as claimed in claim 10, wherein to identify the context of the operation, the one or more instructions, when executed by the at least one processor, cause the system to:
identify one or more real-world objects from the input scene using a Simultaneous Localization and Mapping (SLAM) model;
identify the position of the at least one hand of the user with reference to the one or more real-world objects;
identify one or more hand gestures based on the determined position; and
identify the context of the operation based on identifying the one or more hand gestures.

19. A non-transitory computer readable medium having instructions stored therein, which when executed by a processor cause the processor to execute a method for tracking at least one hand of a user immersed in an Extended Reality (XR) session, the method comprising:
identifying a context of an operation of a head-mounted display (HMD) device and a position of the at least one hand of the user with reference to an input scene;
estimating a plurality of landmarks associated with the at least one hand of the user based on the context of the operation, wherein the plurality of landmarks indicates a set of key points on the at least one hand of the user;
classifying the plurality of landmarks into one of a first group of one or more occluded landmarks and a second group of one or more non-occluded landmarks;
predicting a position of the first group of the one or more occluded landmarks using an artificial intelligence (AI) model based on obtaining hand kinematics associated with the user and the context of the operation;
rendering the at least one hand of the user in the XR session based on the second group of the one or more non-occluded landmarks and the predicted position of the first group of the one or more occluded landmarks; and
tracking the at least one hand of the user based on rendering the at least one hand of the user in the XR session.

20. The non-transitory computer readable medium according to claim 19, wherein the input scene is captured by a camera of the HMD device.
